(19) United States
(12) Patent Application Publication
(10) Pub. No.: US 2026/0046006 A1
(43) Pub. Date: Feb. 12, 2026

(54) NETWORK NODE AND METHOD IN A WIRELESS COMMUNICATIONS NETWORK

(71) Applicant: Telefonaktiebolaget LM Ericsson (publ), Stockholm (SE)

(72) Inventors: Niklas Wernersson, Kungsängen (SE); Karl Werner, Segeltorp (SE)

(21) Appl. No.: 19/150,072

(22) PCT Filed: Jan. 26, 2023
(86) PCT No.: PCT/EP2023/051877

§ 371 Date: Jul. 22, 2025

(51) Int. Cl. H04B 7/06; H04W 4/02

(52) U.S. Cl. CPC H04B 7/06952; H04W 4/025

(57) ABSTRACT

A method for handling synchronization beams for synchronization with a first UE. The network node determines a second set of synchronization beams related to the first UE to be used for the carrier. Determining the second set of synchronization beams related to the first UE to be used for the carrier is based on an obtained position of the first UE. The network node adds the beams of the second set of synchronization beams to an active set of synchronization beams for active UEs. The network node broadcasts a respective synchronization signal in each synchronization beam out of the active set of synchronization beams for the carrier. The network node receives from the first UE, an indication that the first UE has connected to the network node using a specific synchronization beam out of the active set of synchronization beams based on the respective synchronization signals.

### TECHNICAL FIELD

Embodiments herein relate to a network node and a methods therein. In some aspects, they relate to handling synchronization beams for synchronization with a first User Equipment (UE) for an upcoming communication associated with a carrier between the first UE and the network node in a wireless communications network.

### BACKGROUND

In a typical wireless communication network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, with each service area or cell area being served by a radio network node such as a radio access node e.g., a Wi-Fi access point, a Base Station (BS) or a radio base station (RBS), which in some networks may also be denoted, for example, a Base Station (BS), a NodeB, eNodeB (eNB), or gNodeB (gNB) as denoted in Fifth Generation (5G) telecommunications. A service area or cell area is a geographical area where radio coverage is provided by the radio network node. The radio network node communicates over an air interface operating on a radio frequency with the wireless devices within the range of the radio network node.

3rd Generation Partnership Project (3GPP) is the standardization body for specifying the standards for the cellular system evolution, e.g., including 3G, 4G, 5G and the future evolutions. Specifications for Evolved Universal Terrestrial Radio Access (E-UTRA) and Evolved Packet System (EPS) have been completed within the 3GPP. In 4G also called a Fourth Generation (4G) network, EPS is core network and E-UTRA is radio access network. In 5G, 5GC is core network, NR is radio access network. As a continued network evolution, the new release of 3GPP specifies a 5G network also referred to as 5G New Radio (NR) and 5G Core (5GC).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station (BS), the performance is in particular improved if both the transmitter and the receiver no-line of sight path are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. The cell capacity can be increased linearly with respect to the number of antennas at the BS side. Due to that, more and more antennas are employed in BS. Such systems and/or related techniques are commonly referred to as massive MIMO.

A Synchronization Signal Block (SSB) may comprises a Primary Synchronization Signal (PSS), a Secondary Synchronization Signal (SSS), a Physical Broadcast Channel (PBCH), PBCH Demodulation Reference Signals (DMRS) and PBCH Data.

SSB is needed on Millimeter Wave (mmV) carriers, also referred to as mmW cells, at least to:
find a carrier,
acquire time synchronization,
acquire frequency synchronization, and
obtain (parts of) system information.

An SSB may be transmitted to UEs in multiple beams. The beams are selected to jointly define the coverage area of the mmW cell. A transmission needs to be done by using all beams continuously as the SBB is transmitted, assuming that no channel state information is sent to UE Channel State Information (CSI). For NR, up to 64 beams may be used.

The SSB comprises an PSS which spans over one Orthogonal Frequency-Division Multiplexing (OFDM) symbol, an SSS comprising a single OFDM symbol, a PBCH with DMRS for PBCH which spans 3 OFDM symbols.

Each of the signals of the SSB are mapped to the OFDM resource element grid.

As the antenna array grows, the beamforming gain of UE specific signaling increases, which means that the coverage of the UE specific data channel grows. The gain of the SSB beams may also be increased, but more SSB beams will be needed to match the coverage area of the UE specific signaling. Another way to see it is that more SSB beams are needed because each SSB beam gets narrower.

WO2022139635 teaches a method of a radio base station of controlling allocation of resources to wireless communication devices. In the method, a first location with radio coverage using at least a first frequency band and a second frequency band and a second location with radio coverage using the first frequency band is provided. The second frequency band is located at a higher frequency than the first frequency band. It is then temporarily reallocated, resources of the second frequency band from the first location to the second location. This is performed upon acquiring an indication that a wireless communication device at the second location requires improved coverage.

In an example of the method at least one SSB beam for temporarily reallocating resources of the second frequency band from the first location to the second location is reserved. The low-frequency band may be used to establish an initial connection with a second UE acting as an access point for further UEs within the reach of the second UE. By having the base station positioning the second UE for instance by estimating azimuth and elevation, a very narrow beam with a high bandwidth can be created between the base station and the second UE using the high-frequency band via a reserved SSB beam.

However, in this method two frequency bands are needed. This is since the first band will serve as an anchor and the second band will serve as a capacity boost band. Furthermore, when the method relies on that the base station is positioning the second UE the step of obtaining the position will rely on an UL transmission from the second UE. This will in turn imply that communication has already been established with the UE, e.g. through the first band, and through this communication the step of obtaining the position is initiated.

### SUMMARY

As a part of developing embodiments herein, a problem was identified by the inventors and will first be discussed.

As the number of SSB beams grows e.g., due to the factors described above, the overhead in terms of radio resources will also grow. With a large Advanced Antenna System (AAS) this overhead may become significant and will lead to reduced capacity in the cell.

With the traditional always-on transmission of SSB there is also an energy cost associated with increasing the number of SSB beams.

These problems will be even more pronounced when moving to higher frequencies.

An object of embodiments herein is to improve the performance of a wireless communications network using synchronization beams.

According to an aspect of embodiments herein, the object is achieved by a method performed in a network node. The method is for handling synchronization beams for synchronization with a first UE for an upcoming communication associated with a carrier between the first UE and the network node in a wireless communications network. The network node determines a second set of synchronization beams related to the first UE to be used for the carrier. Determining the second set of synchronization beams related to the first UE to be used for the carrier is based on an obtained position of the first UE. The network node adds the beams of the second set of synchronization beams to an active set of synchronization beams for active UEs. The network node broadcasts a respective synchronization signal in each synchronization beam out of the active set of synchronization beams for the carrier. The network node receives from the first UE, an indication that the first UE has connected to the network node using a specific synchronization beam out of the active set of synchronization beams based on the respective synchronization signals.

According to another aspect of embodiments herein, the object is achieved by a network node configured to handle synchronization beams for synchronization with a first UE for an upcoming communication associated with a carrier between the first UE and the network node in a wireless communications network. The network node is further configured to:
Based on an obtained position of the first UE, determine a second set of synchronization beams related to the first UE to be used for the carrier,
add the beams of the second set of synchronization beams to an active set of synchronization beams for active UEs,
broadcast a respective synchronization signal in each synchronization beam out of the active set of synchronization beams for the carrier,
receive from the first UE, an indication that the first UE has connected to the network node using a specific synchronization beam out of the active set of synchronization beams based on the respective synchronization signals.

Embodiments herein e.g., provide the advantage in being beneficial in terms of latency, the time to acquire a carrier for the UE will be reduced if less beams need to be evaluated.

### BRIEF DESCRIPTION OF THE DRAWINGS

Examples of embodiments herein are described in more detail with reference to attached drawings in which:

FIG. 1 is a schematic block diagram illustrating embodiments of a wireless communications network.

FIG. 2 is a flowchart depicting an embodiment of a method in a network node.

FIGS. 3a-b are diagrams illustrating an example scenario of embodiments herein.

FIG. 4 is a schematic block diagram illustrating embodiments of a network node.

FIG. 5 schematically illustrates a telecommunication network connected via an intermediate network to a host computer.

FIG. 6 is a generalized block diagram of a host computer communicating via a base station with a user equipment over a partially wireless connection.

FIGS. 7-10 are flowcharts illustrating methods implemented in a communication system including a host computer, a base station, and a user equipment.

### DETAILED DESCRIPTION

Examples of embodiments herein may relate to a UE positioning based handling of synchronisation beams e.g., for SSB transmission. Examples of embodiments herein may relate to UE positioning-based handling of beams for transmission of reference signals as well as information needed for initial access, for example SSB in NR. In the following this will be called synchronization beams.

As mentioned above an advantage is that the number of transmitted synchronisation beams e.g., SSB beams, will be kept low. This means a lower overhead for SSB, which may be very beneficial if the AAS size is very large. It may also be beneficial in terms of latency, the time to acquire the carrier for the UE will be reduced if less beams need to be evaluated.

In NR for FR2 there is also a limit to 64 logical SSBs, some embodiments herein allow more SSB beams in the wireless communications network, but the number of active SSB beams is still limited to 64.

In general, some embodiments herein also allow a carrier to be partially or completely turned-off. This leads to energy efficiency improvements.

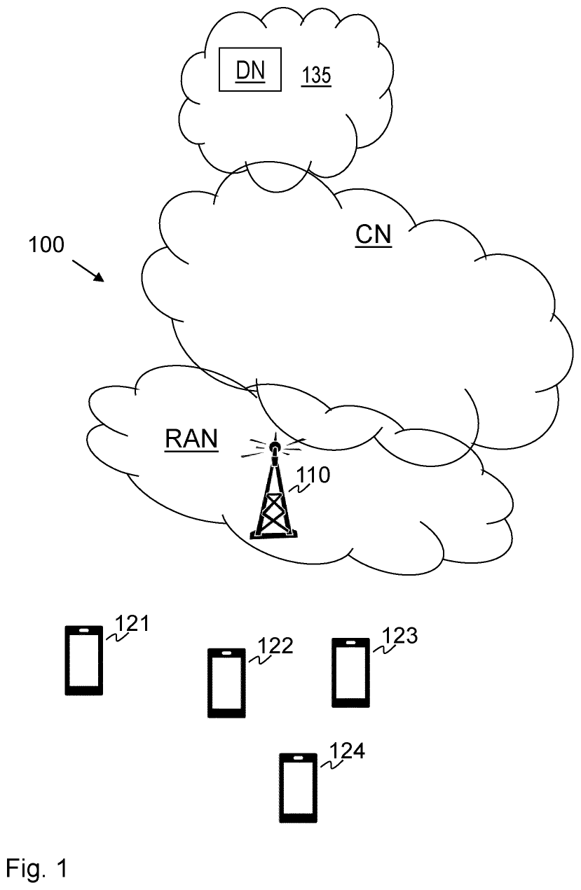

FIG. 1 is a schematic overview depicting a wireless communications network 100, wherein embodiments herein may be implemented. The wireless communications network 100 comprises one or more RANs and one or more CNs. The wireless communications network 100 may use 5G NR but may further use a number of other different technologies, such as, 6G, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes, such as a network node 110, operate in the wireless communications network 100. The network node 110 e.g. provides a number of cells and may use these cells for communicating with other radio nodes, such as e.g. UEs 121, 122. The network node 110 may be a transmission and reception point e.g. a network node, a radio access network node such as a base station, a radio base station, a NodeB, an evolved Node B (eNB, eNodeB, eNode B), an NR/g Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE served by the network node 110 depending e.g. on the radio access technology and terminology used.

UEs, such as a first UE 121 and one or more other UEs referred to as second UEs 122, 123, 124, operate in the wireless communications network 100. The respective first UE 121 and second UEs 122, 123, 124 may each e.g. be, an NR device, a mobile station, a wireless terminal, an NB-IoT device, an enhanced Machine Type Communication (eMTC) device, an NR RedCap device, a CAT-M device, a Vehicle-to-everything (V2X) device, Vehicle-to-Vehicle (V2V) device, a Vehicle-to-Pedestrian (V2P) device, a Vehicle-to-Infrastructure (V2I) device, and a Vehicle-to-Network (V2N) device, a Wi-Fi device, an LTE device and a non-access point (non-AP) STA, a STA, that communicates via a base station such as e.g. the network node 110, one or more Access Networks (AN), e.g. RAN, to one or more core networks (CN). It should be understood by the skilled in the art that the term UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

In some embodiments the term UE refers to a device used directly by an end-user to communicate, e.g. a hand-held telephone or a laptop computer equipped with a mobile broadband adapter.

In some embodiments the term UE refers to an object that is equipped or is carrying a device used directly by an end-user to communicate. This may e.g. be any one out of:
A robot equipped/carrying a device used for communication.
A person carrying a device used for communication.
A vehicle equipped/carrying a device used for communication.

Methods herein may in one aspect be performed by the network node 110. As an alternative, a Distributed Node (DN) and functionality, e.g. comprised in a cloud 135 as shown in FIG. 1, may be used for performing or partly performing the methods of embodiments herein.

Some embodiments herein, e.g. provide a way to make a set of SSB beams for a carrier, specific to a set of active UEs, e.g. comprising the UEs 121, 122, on that carrier. This may be performed based on information of positions of the UEs, such as the UEs 121, 122, obtained e.g., from a positioning system.

A number of embodiments will now be described, some of which may be seen as alternatives, while some may be used in combination.

In embodiments herein different sets of synchronization beams are used.

A first set of possible synchronization beams. These synchronization beams relate to the possible synchronization beams that the network node 110 has capacity to provide. Some of them may already be part of an active set of synchronization beams and some of them may not be part of an active set of synchronization beams.

A second set of synchronization beams. These synchronization beams are selected to cover the direction(s) towards the first UE 121 to be used for the carrier.

An active set of synchronization beams. These synchronization beams are the beams that are used to transmit SSB, or in general synchronization signals and parts of system information that are used by active UEs 121, 122 for communications in the carrier. Some of these beams may be used in the carrier by more than one UE, and some beams in the active set may not be used by any UE. According to embodiments herein, the network node 110 aims to provide a way to make a set of active synchronization beams for the carrier, specific to UEs active on that carrier, e.g. comprising the UEs 121, 122. This is an advantage since the cost in terms of overhead for transmitting the active set of synchronization beams is lower than the cost of transmitting the first set of possible synchronisation beams. The first UE 121 may, based on measurements of the transmitted beams from the active set, select one of the synchronization beams for its upcoming communication in the carrier.

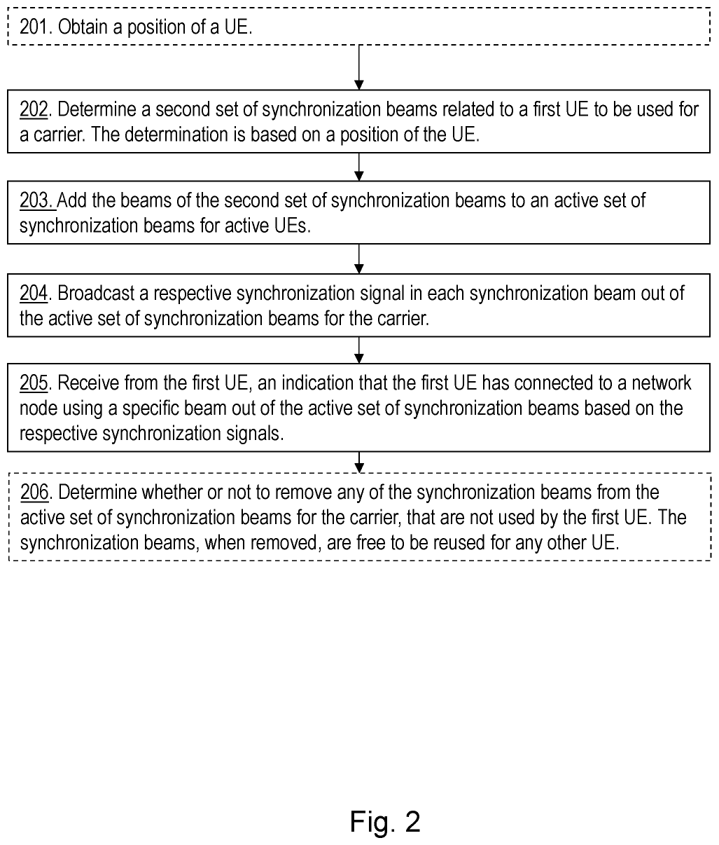

FIG. 2 shows exemplary embodiments of a method performed in the network node 110. The method is for handling synchronization beams for synchronization with the first UE 121 for an upcoming communication associated with a carrier between the first UE 121 and the network node 110 in the wireless communications network 100.

In some embodiments, the network node 110 provides a first set of possible synchronization beams. As mentioned above, these are the possible synchronization beams that the network node 110 has capacity to provide.

The synchronization beams may be represented by SSBs. A carrier when used herein may comprise a number of beams to be used by one or more UEs such as e.g., the first UE 121 and possibly the second UE. The method comprises the following actions, which actions may be taken in any suitable order. Optional Actions are shown as dashed boxes in FIG. 2.

### Action 201

The network node 110 obtains a position of the UE 120. The position of the UE 120 may be obtained by any one or more out of:
One or more cameras detecting the first UE 120 and estimating its position,
one or more microphones detecting the first UE 120 and estimating its position,
receiving the position from the first UE 121, and
using positioning functionality in the wireless communications network 100.

By using the positioning of the first UE 121 and any other UE, based on the cameras or the microphones, no signalling requiring UL signalling with the UEs is needed.

This is an advantage since this implies that the UE 121 does not need to have an established communication with the network node 110, e.g. through some other band.

In some embodiments, the position of the UE 120, is represented by a direction from the network node 110 to the UE 120. The term position may thus comprise also a direction to a UE such as the first UE 121 and any other UE.

The direction may e.g., relate to any of an estimated line of sight path or an estimated no-line of sight path, e.g., a strong no-line of sight path.

The positioning may be obtained from a system that communicates with the network node 110. The system estimates the position of a UE such as the first UE 121. Examples of such systems, e.g. comprise optical based systems, acoustic positioning-based systems, radar like systems and inertial sensing-based systems.

### Action 202

The network node 110 determines a second set of synchronization beams. These synchronization beams are related to the first UE 121 to be used for the carrier. The determining is based on the obtained position of the first UE 121. The network node 110 may need to determine some synchronization beams that are directed towards the first UE 121. These are based on the first UE 121 position. These synchronization beams will later on be included in the set of active synchronization beams. These are to be used for the communication in the carrier.

As mentioned above, in some embodiments the network node 110 provides a first set of possible synchronization beams. In some of these embodiments, the second set of synchronization beams may be selected, such as determined, from the first set of synchronization beams.

### Action 203

The network node 110 adds the beams of the second set of synchronization beams to an active set of synchronization beams for active UEs 121, 122. The active UEs 121, 122 may comprise the first UE 121 and the second UE 122.

In some embodiments, adding the beams of the second set of synchronization beams to the active set of synchronization beams for active UEs 121, 122, are only performed for beams that when checked by the network node 110, are not already included in the active set of synchronization beams. This may be to avoid duplication since duplication will increase the amount of radio resources required for the transmission.

### Action 204

The network node 110 broadcasts a respective synchronization signal in each synchronization beam out of the active set of synchronization beams for the carrier.

Since the beams of the second set of synchronization beams have been added to the active set of synchronization beams for active UEs 121, 122, it is assured that some of the broadcasted synchronization signals will be heard by the first UE 121, that is the synchronization signals sent in the second set of synchronization beams.

### Action 205

The network node 110 receives an indication from the first UE 121. The indication indicates that the first UE 121 has connected to the network node 110 using a specific synchronization beam out of the active set of synchronization beams based on the respective synchronization signals.

This conforms which of the synchronization beams from the active set of synchronization beams for the carrier, that are used by the first UE 121. The network node 110 may then identify which of the synchronization beams from the second set of synchronization beams comprised in the active set of synchronization beams that are not used by the first UE 121.

### Action 206

The network node 110 may then determine based on the indication, whether or not to remove any of the synchronization beams from the active set of synchronization beams for the carrier, that are not used by the first UE 121.

In this way the set of the active set of synchronization beams can be updated to just include beams that are used by active UEs on the carrier, e.g. comprising the first UE 121.

The method may then be repeated for other active UEs which e.g., may be the second UE 122.

Embodiments herein such as the embodiments mentioned above will now be further described and exemplified. The text below is applicable to and may be combined with any suitable embodiment described above.

Note that while the description below is biased towards NR in FR2 the embodiments herein also may apply to other bands, and other RATs. It should be noted that the issue addressed by embodiments herein, coverage and/or overhead of common synchronization signals, such as SSB, with systems relying on high-gain dynamic UE specific beamforming, is rather fundamental in nature. This means that any system that requires same coverage of common signals, transmitted using no assumption of the radio channel to the UE, as the coverage of UE specific signals, transmitted and/or received using assumptions of the channel to the UE, will require more resources to be allocated to the common signals as the array size grows.

It should also be noted that although embodiments herein is described when the positioning systems estimates a position (x,y,z) other cartesian coordinate systems are also applicable. The positioning system may for instance estimate the azimuth and zenith angles at the network node towards the first UE 121. In other embodiments the positioning system determines a fingerprint or proxy for the position, wherein the proxy is mapped to the synchronization beams.

In the below examples the synchronization beams may be represented by SSB beams and the synchronization signals may be represented by SSB signals.

However, the wordings synchronization beams and SSB beams may be used interchangeably herein and the wordings the synchronization signals and SSB signals may also be used interchangeably herein.

Logical SSB index may be signaled using PBCH for data and DMRS. It is tied to a specific set of transmission opportunities. There may in NR be up to 64 logical indices. The set of indices is signaled, not all are necessarily being used.

An SSB beam in this context is a set of transmission weights—one per antenna and/or radio and/or antenna-port.

The first UE 121 assumes that the SSB beam is the same for a given logical SSB index during its session.

Embodiments herein applies to the network node 110 side, e.g., a gNB side, in the wireless communications network 100 with at least one carrier which may be a higher frequency carrier such as mmW or higher.

Below, some example embodiments of the method are described more in detail. Some of the steps in the example are optional.

A positioning system communicating with the network node 110 estimates a position (x,y,z) of the first UE 121.

This relates to and may be combined with Action 201 described above.

In some embodiments a camera is used to obtain a video and/or photos of an environment and image processing techniques are used to detect a set of UEs such as e.g. the first UE 121, and to estimate their position. This may be applicable in for instance a factory scenario where a set of UEs being represented by mobile robots are monitored using cameras. In some other embodiments an outdoor deployment is used instead and the UEs such as the UE 121 are represented by devices of humans and/or vehicles in an outdoor environment.

In some other example embodiments acoustic positioning is instead used with a microphone array.

Information about the position of the UE such as the first UE 121 is then transferred to the network node.

Further, the first UE 121 may estimate its position, e.g. by using GPS, and report this to the network node 110, e.g. a gNB, using a lower carrier. A lower carrier when used herein e.g. mean a carrier operating on a frequency band with a lower carrier frequency, which may be assumed to have better coverage. In some other embodiments positioning functionality in LTE or NR related to the wireless communications network 100 is instead used by the network node 110 to obtain the position of the first UE 121.

In some embodiments the first UE 121 is equipped with a marker, such as e.g. any one out of a sticker, a symbol, a code, a sign, a color, or Light Emitting Diodes (LED)s that will simplify the positioning for the position system. Again, considering the factory scenario with a set of UEs including the first UE 121 being represented by robots, it may be possible to equip the robots with a certain lamp and/or visual symbol that makes it easier for the position system to detect and localize the first UE 121.

The network node 110 determines whether the first UE 121 benefits from connecting to the band of the carrier.

In some embodiments the network node 110 will try to connect to all UEs including the first UE 121 that are positioned, such as e.g. detected by the positioning system. This may e.g. be to figure out whether or not to trigger the determining of the second set of synchronization beams related to the first UE 121 to be used for the carrier. If the first UE 121 benefits from connecting to the band of the carrier, the determining of the second set of synchronization beams is triggered.

This may be performed by using a buffer status of the first UE 121 in case the first UE 121 is connected also to another, e.g., lower carrier. If there is much data in the buffer there may be a benefit in connecting to the carrier.

This may also be based on a service type, e.g., if the first UE 121 runs an XR service for example, higher carriers may be suitable. An XR service when used herein e.g., means a service using virtual reality, augmented reality or similar.

In another embodiment the determination is based on the overall resource utilization of a cell.

The network node 110 obtains a mapping function from the estimated position to determine the second set of beams for use on the carrier based on the first UE position.

This relates to and may be combined with Action 202 described above.

This is to identify synchronization beams directed towards the first UE 121.

In the case of a camera-based system the estimated position of the first UE 121, the position of the network node 110 and potentially also the position of the camera may hence be used to derive a set of angles corresponding to estimated line-of-sight directions and/or strong no-line-of-sight directions between the network node 110 and the first UE 121. Based on this set of angles the second set of synchronization beams with similar angles for their maximum gain may be determined.

The mapping may be based on the explicit position of the first UE 121 or azimuth and zenith angles between the network node 110 and the first UE 121, e.g., determined from the positioning system.

The mapping may be in the form of a table mapping position or azimuth and zenith angles to indices of the synchronization beams.

The mapping may be trained using CSI-Reference Signals (RS) beam-sweeps on the carrier.

The mapping may be trained based on historical data.

The network node 110 adds the determined second set of synchronization beams to the active set of synchronization beams for the carrier, this set is not UE specific. Each beam may be assigned a logical SSB index.

This relates to and may be combined with Action 203 described above.

The network node 110 may check to ensure that a synchronization beam being added to the active set of synchronization beams for the carrier is not already part of the set. In some embodiments a counter may then be increased for that beam such that the number of active users camping on that SSB beam is tracked.

The logical SSB index assigned to the synchronization beam may be obtained from a list of logical SSB indices that are free, or e.g., through a fixed mapping.

The network node 110 transmits synchronization signals in the active set of synchronization beams for the carrier, each beam may use its assigned logical beam index and the resources associated with the logical beam index.

This relates to and may be combined with Action 204 described above.

The network node 110 broadcasts e.g., transmits synchronization signals such as SSB in the synchronization beams of the active set of synchronization beams. This may comprise applying a precoder and/or beamforming weight and/or port-to-antenna mapping to the synchronization signal. The precoder and/or beamforming weight and/or port-to-antenna mapping comprise phase and amplitude information for the antennas in the network node 110.

The first UE 121 receives synchronization signals on the carrier and connects to the carrier using any of the SSBs in the active set of beams for the carrier.

This relates to and may be combined with Action 205 described above.

In this step the network node 110 obtains an indication, e.g. an SSB logical index, indicating that the first UE 121 has connected to the network node (110) using a specific synchronization beam out of the active set of synchronisation beams based on measurements of the synchronization signals in the active set.

In some embodiments this indicated specific synchronization beam is used to update, e.g., the mapping function, from the estimated position (x,y,z) to a set of synchronization beams. This means that the estimated position which was used to determine the second set of synchronization beams, is compared to the beam actually used by the UE, the comparison being used to update an algorithm/parameters of an algorithm that uses the estimated position to determine the second set of synchronization beams.

The network node 110 determines if any synchronization beams are unused.

In response to an SSB beam being unused it is removed from the active set of beams for the carrier (and the logical SSB index is then free for re-use).

This relates to and may be combined with Action 206 described above.

The network node 110 determines based on the indication, whether or not to remove any of the synchronization beams from the active set of synchronisation beams for the carrier, that are not used by the first UE 121. These synchronization beams may, when removed, be free to be reused for any other UE.

In some embodiment this may further be determined according to any one or more out of:
When a UE such as the first UE 121, is disconnected from the carrier.
Based on an activity time for a user.
When it is determined no UE is using the associated SSB index.
In response to a new synchronization beam being added. This may be to be able to manage a limited number of SSB logical indexes.

In an example of a table stored at the network node 110 indicates a mapping of synchronization beams such as SSB beams to SSB logical indices. This is illustrated in Table 1. Note that this may change as a UE such as e.g. the first UE 121 leaves the carrier or as a enters the carrier.

TABLE 1

| | SSB physical | SSB beam (index | |
|---|---|---|---|
| SSB logical | resources | of beam weigths, | UEs associated |
| index | (OFDM symbols) | or beam weigths) | with SSB beam |
| 0 | Slot 0 | Beam index 8 | UE 121, UE122 |
| 1 | Slot 1 | Beam index 5 | UE121 |
| 2 | Slot 2 | Beam index 9 | UE122 |
| 3 | Slot 3 | Beam index 23 | UE123 |

In an example scenario, the UE 122 is determined to be inactive and the UE 124 is added to mmW. This is illustrated in Table 2.

TABLE 2

| | SSB physical | SSB beam (index | |
|---|---|---|---|
| SSB logical | resources | of beam weigths, | UEs associated |
| index | (OFDM symbols) | or beam weigths) | with SSB beam |
| 0 | Slot 0 | Beam index 8 | UE1, UE2 |
| 1 | Slot 1 | Beam index 5 | UE1 |
| 2 | Slot 2 | Beam index 13 | UE4 |
| 3 | Slot 3 | Beam index 23 | UE3 |

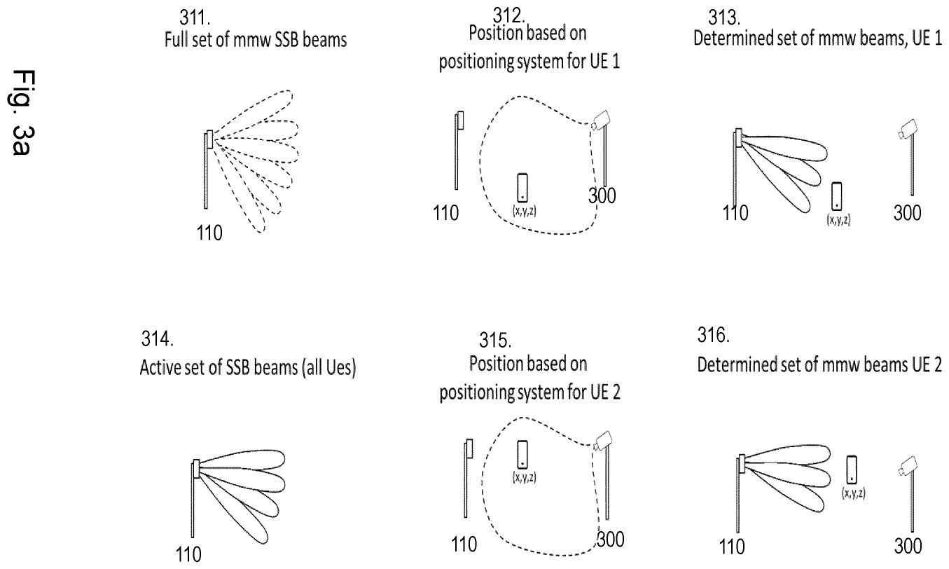

FIG. 3a illustrates the following example scenario when the network node 110 has access to a camera 300.

References 311, 312 and 313 relate to the determining of the second set of synchronization beams related to the first UE 121, referred to as UE 1 in the figure.

311 illustrates the network node 110 providing the first set of possible synchronization beams. In 312, the camera 300-based positioning system estimates the position of UE 1 and sends it to the network node 110. 313 illustrates the determined second set of synchronization beams related to UE 1 to be used for the carrier. These beams are added to the active set of synchronization beams which are illustrated in 314.

In 315, the camera 300-based positioning system estimates the position of UE 2 and sends it to the network node 110. 316 illustrates the determined second set of synchronization beams related to UE 2 to be used for the carrier. These beams will be added to the active set of synchronization beams. The synchronization signal transmission may be done on a subset of the set of all potential SSB beams that corresponds to the union of the beams determined for the two UEs UE 1 and UE 2.

FIG. 3b illustrates another example scenario wherein the camera 300 is mounted on the network node 110 to, based on the UE position, derive a set of angles corresponding to estimated line-of-sight directions and/or strong no-line-of-sight directions between the network node 110 and the first UE 121.

References 321, 322 and 323 relate to the determining of the second set of synchronization beams related to the first UE 121, referred to as UE 1 in the figure.

321 illustrates the network node 110 providing the first set of possible synchronization beams. In 322, the network node 110 uses the camera 300 to estimate the position of UE 1 based on a derived set of angles corresponding to an estimated line-of-sight directions and/or strong no-line-of-sight directions between the network node 110 and UE 1. 323 illustrates the second set of synchronization beams related to UE 1 to be used for the carrier determined based on the derived set of angles. These beams are added to the active set of synchronization beams which are illustrated in 324.

In 325, the network node 110 uses the camera 300 to estimate the position of UE 2 based on a derived set of angles corresponding to an estimated line-of-sight directions and/or strong no-line-of-sight directions between the network node 110 and UE 2. 326 illustrates the second set of synchronization beams related to UE 2 to be used for the carrier determined based on the derived set of angles. These beams will be added to the active set of synchronization beams. The synchronization signal transmission may be done on a subset of the set of all potential SSB beams that corresponds to the union of the beams determined for the two UEs UE 1 and UE 2.

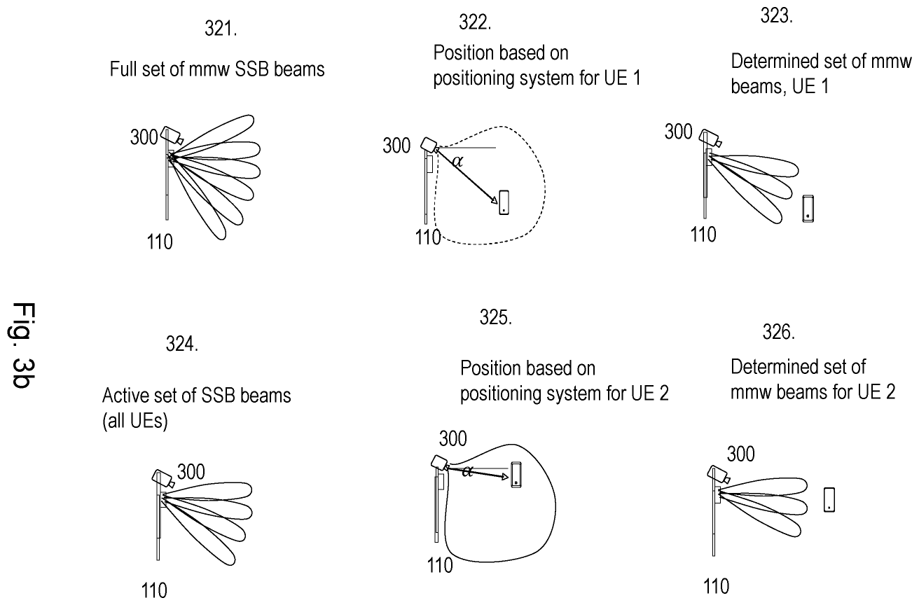

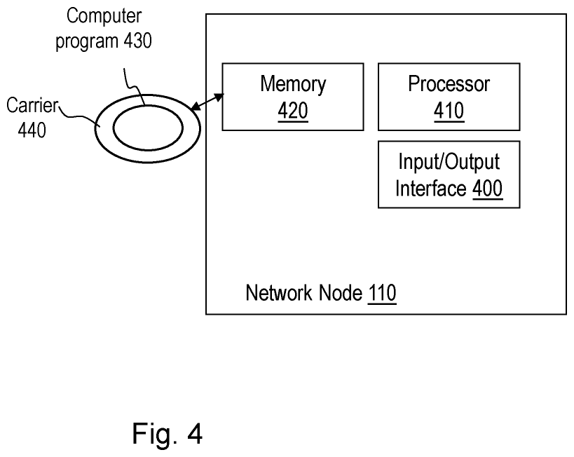

FIG. 4 illustrates an example of an arrangement in the network node 110.

The network node 110 is configured to handle synchronization beams for synchronization with the first UE 121 for an upcoming communication associated with a carrier between the first UE 121 and the network node 110 in the wireless communications network 100.

The network node 110 may comprise an input and output interface 400 configured to communicate e.g., with any of the networking entities operating in the communications network 100 of embodiments herein such as e.g., the second radio node 120. The input and output interface 400 may comprise a receiver, e.g., wired and/or wireless, (not shown) and a transmitter, e.g., wired and/or wireless, (not shown).

The network node 110 is further configured to, based on an obtained position of the first UE 121, determine a second set of synchronization beams related to the first UE 121 to be used for the carrier.

The network node 110 is further configured to, add the beams of the second set of synchronization beams to an active set of synchronization beams for active UEs 121, 122, The network node 110 is further configured to broadcast a respective synchronization signal in each synchronization beam out of the active set of synchronization beams for the carrier.

The network node 110 is further configured to receive from the first UE 121, an indication that the first UE 121 has connected to the network node 110 using a specific synchronization beam out of the active set of synchronization beams based on the respective synchronization signals.

The network node 110 may further be configured to determine based on the indication, whether or not to remove any of the synchronization beams from the active set of synchronization beams for the carrier, that are not used by the first UE 121.

In some embodiments, the network node 110 is further configured to obtain a position of the UE 120.

In some embodiments, the network node 110 is configured to obtain the position of the UE 120 by any one or more out of:
one or more cameras detecting the first UE 120 and estimating its position,
one or more microphones detecting the first UE 120 and estimating its position,
receiving the position from the first UE 121, and
using positioning functionality in the wireless communications network 100.

In some embodiments, the position of the UE 120 is adapted to be represented by a direction from the network node 110 to the UE 120, which direction is adapted to relate to any of: an estimated line of sight path or an estimated no-line of sight path.

In some embodiments, the network node 110 is configured to provide a first set of possible synchronization beams, and wherein the network node 110 is further configured to determine the second set of synchronization beams from the first set of synchronization beams.

In some embodiments, the network node is configured to add the beams of the second set of synchronization beams to the active set of synchronization beams for active UEs 121, 122, only for beams that, when checked by the network node 110, are not already included in the active set of synchronization beams.

The embodiments herein may be implemented through a respective processor or one or more processors, such as at least one processor 410 of a processing circuitry in the network node 110 depicted in FIG. 4, together with computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 420 comprising one or more memory units. The memory 420 comprises instructions executable by the processor in the network node 110. The memory 420 is arranged to be used to store instructions, data, configurations, measurements, parameters, and applications to perform the methods herein when being executed in the network node 110.

In some embodiments, a computer program 430 comprises instructions, which when executed by the at least one processor 410, cause the at least one processor 410 of the network node 110 to perform the actions above.

In some embodiments, a respective carrier 440 comprises the respective computer program 430, wherein the carrier 440 is one of an electronic signal, an optical signal, an electromagnetic signal, a magnetic signal, an electric signal, a radio signal, a microwave signal, or a computer-readable storage medium.

Those skilled in the art will also appreciate that the functional modules in the network node 110, described below may refer to a combination of analogue and digital circuits, and/or one or more processors configured with software and/or firmware, e.g., stored in the network node 110, that when executed by the respective one or more processors such as the at least one processor 410 described above cause the respective at least one processor 410 to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

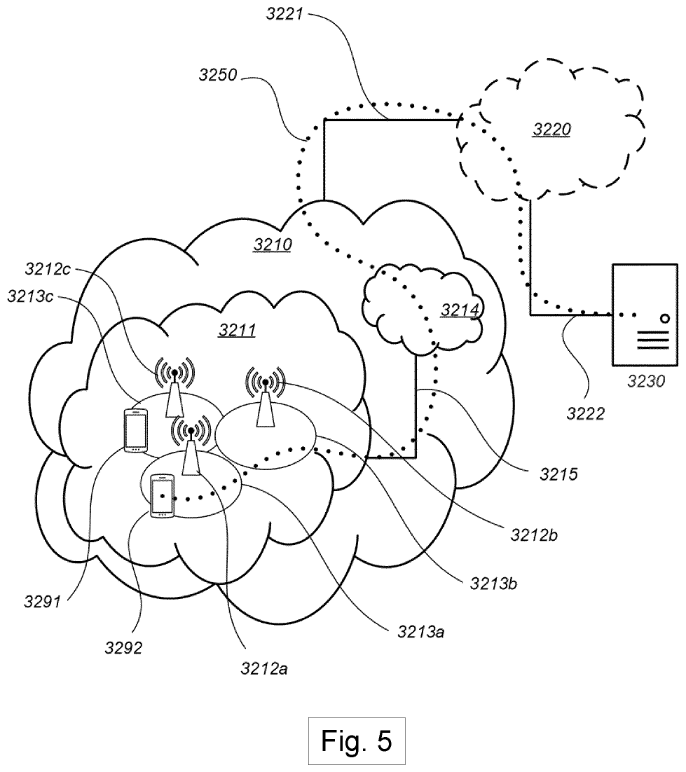

With reference to FIG. 5, in accordance with an embodiment, a communication system includes a telecommunication network 3210, such as a 3GPP-type cellular network, e.g. thh wireless communications network 100, which comprises an access network 3211, such as a radio access network, and a core network 3214. The access network 3211 comprises a plurality of base stations 3212a, 3212b, 3212c, e.g., the network node 110 or the second radio node 120, such as AP STAs NBs, eNBs, gNBs or other types of wireless access points, each defining a corresponding coverage area 3213a, 3213b, 3213c. Each base station 3212a, 3212b, 3212c, e.g. radio network nodes 141,142, is connectable to the core network 3214 over a wired or wireless connection 3215. A first user equipment (UE), e.g. the network node 110 or the second radio node 120, such as a Non-AP STA 3291 located in coverage area 3213c is configured to wirelessly connect to, or be paged by, the corresponding base station 3212c, e.g., the network node 110. A second UE 3292, e.g., any of the one or more second UEs 122, such as a Non-AP STA in coverage area 3213a is wirelessly connectable to the corresponding base station 3212a, e.g., the network node 110. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 5 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

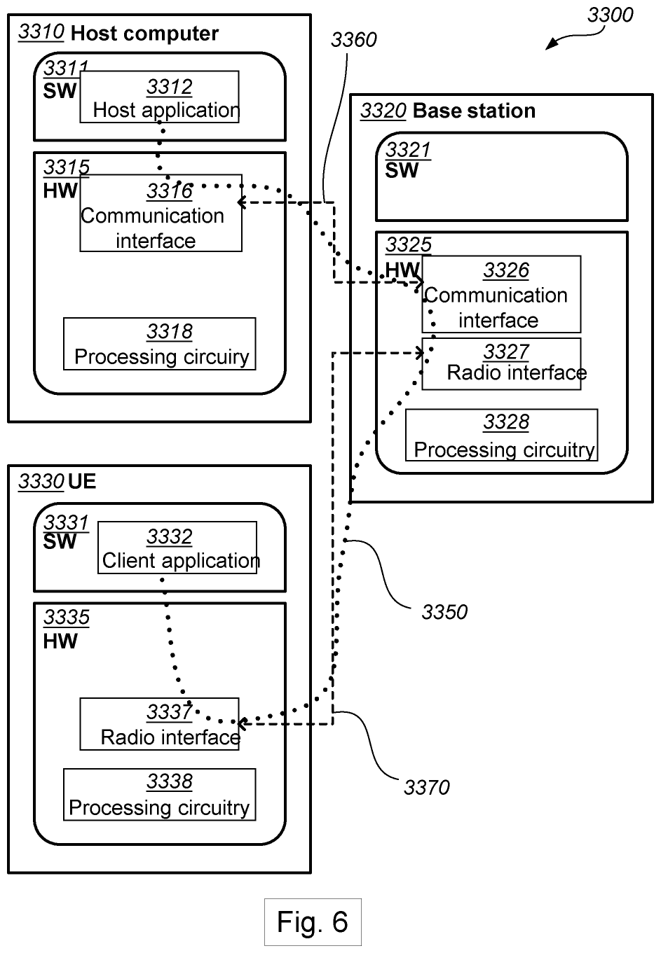

Example implementations, in accordance with an embodiment, of the UE, base station and host computer discussed in the preceding paragraphs will now be described with reference to FIG. 6. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 6) served by the base station 3320. The communication interface 3326 may be configured to facilitate a connection 3360 to the host computer 3310. The connection 3360 may be direct or it may pass through a core network (not shown in FIG. 6) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 6 may be identical to the host computer 3230, one of the base stations 3212a, 3212b, 3212c and one of the UEs 3291, 3292 of FIG. 5, respectively. This is to say, the inner workings of these entities may be as shown in FIG. 6 and independently, the surrounding network topology may be that of FIG. 5.

In FIG. 6, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: data rate, latency, power consumption and thereby provide benefits such as e.g. the applicable corresponding effect on the OTT service: reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

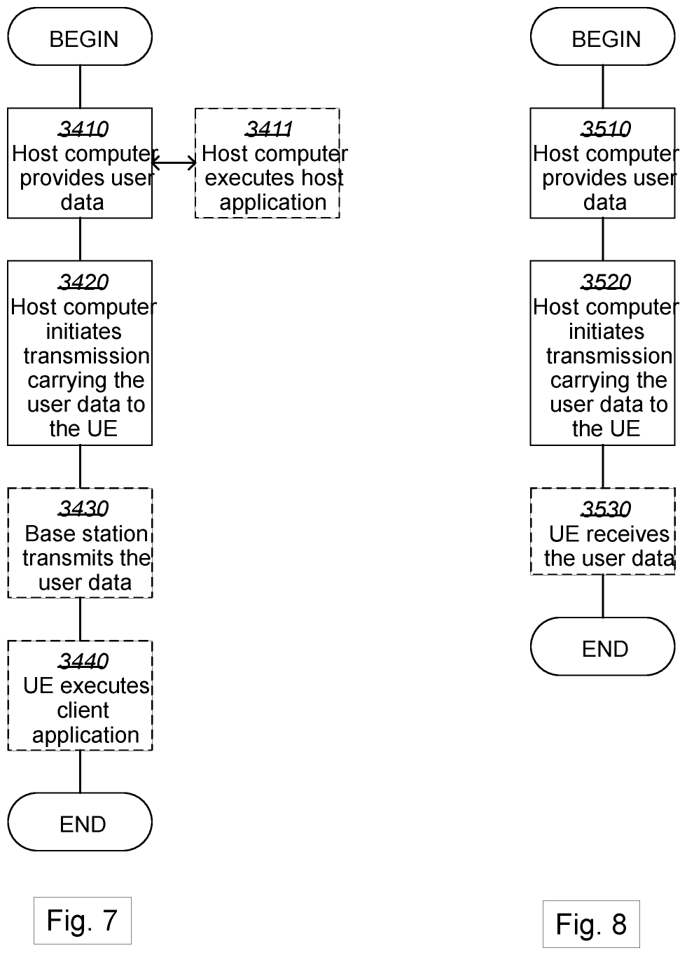

FIG. 7 is a flowchart illustrating a method implemented in a communication system, in accordance with one embodiment. The communication system includes a host computer, a base station such as an AP STA, and a UE such as a Non-AP STA which may be those described with reference to FIG. 5 and FIG. 6. For simplicity of the present disclosure, only drawing references to FIG. 7 will be included in this section. In a first Step 3410 of the method, the host computer provides user data. In an optional sub Step 3411 of the first Step 3410, the host computer provides the user data by executing a host application. In a second Step 3420, the host computer initiates a transmission carrying the user data to the UE. In an optional third Step 3430, the base station transmits to the UE the user data which was carried in the transmission that the host computer initiated, in accordance with the teachings of the embodiments described throughout this disclosure. In an optional fourth Step 3440, the UE executes a client application associated with the host application executed by the host computer.

FIG. 8 is a flowchart illustrating a method implemented in a communication system, in accordance with one embodiment. The communication system includes a host computer, a base station such as an AP STA, and a UE such as a Non-AP STA which may be those described with reference to FIG. 5 and FIG. 6. For simplicity of the present disclosure, only drawing references to FIG. 8 will be included in this section. In a first Step 3510 of the method, the host computer provides user data. In an optional sub step (not shown) the host computer provides the user data by executing a host application. In a second Step 3520, the host computer initiates a transmission carrying the user data to the UE. The transmission may pass via the base station, in accordance with the teachings of the embodiments described throughout this disclosure. In an optional third Step 3530, the UE receives the user data carried in the transmission.

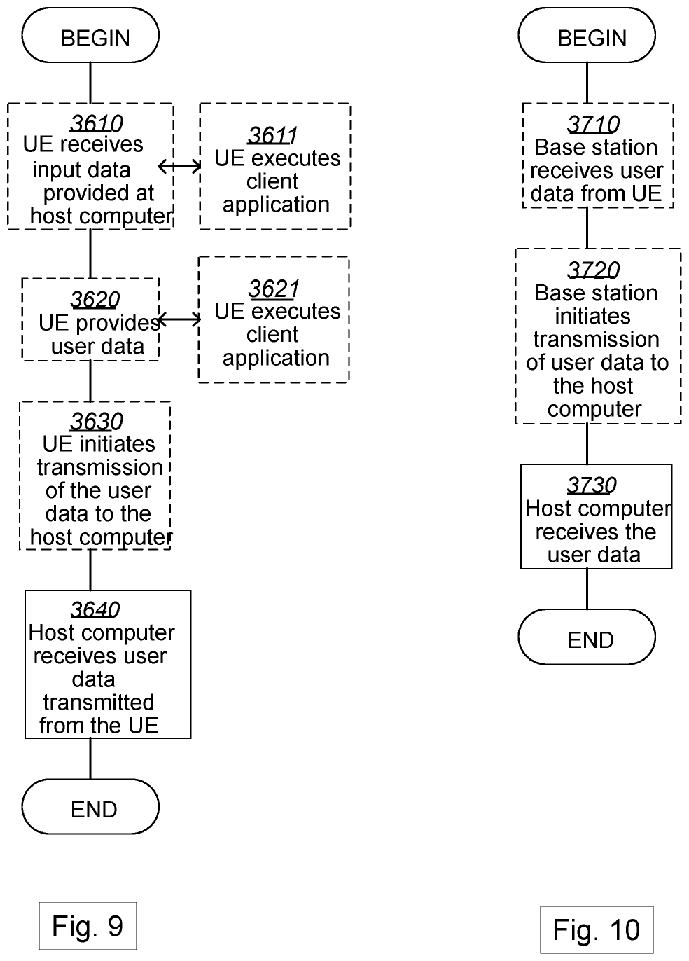

FIG. 9 is a flowchart illustrating a method implemented in a communication system, in accordance with one embodiment. The communication system includes a host computer, a base station such as an AP STA, and a UE such as a Non-AP STA which may be those described with reference to FIG. 5 and FIG. 6. For simplicity of the present disclosure, only drawing references to FIG. 9 will be included in this section. In an optional first Step 3610 of the method, the UE receives input data provided by the host computer. Additionally or alternatively, in an optional second Step 3620, the UE provides user data. In an optional sub Step 3621 of the second Step 3620, the UE provides the user data by executing a client application. In a further optional sub Step 3611 of the first Step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third sub Step 3630, transmission of the user data to the host computer. In a fourth Step 3640 of the method, the host computer receives the user data transmitted from the UE, in accordance with the teachings of the embodiments described throughout this disclosure.

FIG. 10 is a flowchart illustrating a method implemented in a communication system, in accordance with one embodiment. The communication system includes a host computer, a base station such as an AP STA, and a UE such as a Non-AP STA which may be those described with reference to FIG. 5 and FIG. 6. For simplicity of the present disclosure, only drawing references to FIG. 10 will be included in this section. In an optional first Step 3710 of the method, in accordance with the teachings of the embodiments described throughout this disclosure, the base station receives user data from the UE. In an optional second Step 3720, the base station initiates transmission of the received user data to the host computer. In a third Step 3730, the host computer receives the user data carried in the transmission initiated by the base station.

When using the word “comprise” or “comprising” it shall be interpreted as non-limiting, i.e. meaning “consist at least of”.

The embodiments herein are not limited to the preferred embodiments described above. Various alternatives, modifications and equivalents may be used.

1. A method performed in a network node for handling synchronization beams for synchronization with a first User Equipment (UE) for an upcoming communication associated with a carrier between the first UE and the network node in a wireless communications network, the method comprising:
determining a second set of synchronization beams related to the first UE to be used for the carrier, which determining is based on an obtained position of the first UE,
adding the beams of the second set of synchronization beams to an active set of synchronization beams for active UEs,
broadcasting a respective synchronization signal in each synchronization beam out of the active set of synchronization beams for the carrier, and
receiving from the first UE, an indication that the first UE has connected to the network node using a specific synchronization beam out of the active set of synchronization beams based on the respective synchronization signals.

2. The method according to claim 1, further comprising:
obtaining a position of the UE, and
determining based on the indication, whether or not to remove any of the synchronization beams from the active set of synchronization beams for the carrier, that are not used by the first UE.

3. The method according to claim 1, wherein the position of the UE is obtained by any one or more out of:
one or more cameras detecting the first UE and estimating its position,
one or more microphones detecting the first UE and estimating its position,
receiving the position from the first UE, and
using positioning functionality in the wireless communications network.

4. The method according to claim 1, wherein the position of the UE is represented by a direction from the network node to the UE, which direction relates to any of: an estimated line of sight path or an estimated no-line of sight path.

5. The method according to claim 1, wherein the network node provides a first set of possible synchronization beams, and wherein the second set of synchronization beams are determined from the first set of synchronization beams.

6. The method according to claim 1, wherein the adding of the beams of the second set of synchronization beams to the active set of synchronization beams for active UEs are only performed for beams that when checked by the network node, are not already included in the active set of synchronization beams.

7. A computer program comprising instructions, which when executed by a processor, causes the processor to perform actions according to claim 1.

8. A carrier comprising the computer program of claim 7, wherein the carrier is one of an electronic signal, an optical signal, an electromagnetic signal, a magnetic signal, an electric signal, a radio signal, a microwave signal, or a computer-readable storage medium.

9. A network node configured to handle synchronization beams for synchronization with a first User Equipment (UE) for an upcoming communication associated with a carrier between the first UE and the network node in a wireless communications network, the network node further being configured to:
based on an obtained position of the first UE, determine a second set of synchronization beams related to the first UE to be used for the carrier,
add the beams of the second set of synchronization beams to an active set of synchronization beams for active UEs,
broadcast a respective synchronization signal in each synchronization beam out of the active set of synchronization beams for the carrier, and
receive from the first UE, an indication that the first UE has connected to the network node using a specific synchronization beam out of the active set of synchronization beams based on the respective synchronization signals.

10. The network node according to claim 9, further configured to any one or more out of:
obtain a position of the UE, and
determine based on the indication, whether or not to remove any of the synchronization beams from the active set of synchronization beams for the carrier, that are not used by the first UE, which synchronization beams, when removed are adapted to be free to be reused for any other UE.

11. The network node according to claim 9, wherein the network node is configured to obtain the position of the UE by any one or more out of:
one or more cameras detecting the first UE and estimating its position,
one or more microphones detecting the first UE and estimating its position,
receiving the position from the first UE, and
using positioning functionality in the wireless communications network.

12. The network node according to claim 9, wherein the position of the UE is adapted to be represented by a direction from the network node to the UE, which direction is adapted to relate to any of: an estimated line of sight path or an estimated no-line of sight path.

13. The network node according to claim 9, wherein the network node is configured to provide a first set of possible synchronization beams, and wherein the network node is further configured to determine the second set of synchronization beams from the first set of synchronization beams.

14. The network node according to claim 9, wherein the network node is configured to add the beams of the second set of synchronization beams to the active set of synchronization beams for active UEs only for beams that, when checked by the network node, are not already included in the active set of synchronization beams.
